(19) United States
(12) Patent Application Publication
(10) Pub. No.: US 2004/0228625 A1
(43) Pub. Date: Nov. 18, 2004

(54) Disposable camera for photos with various

(76) Inventor: Soon Chul Moon, Los Angeles, CA (US)

Correspondence Address: Eugene Oak, Ph.D.,J.D., 610 S. Van Ness Ave., Los Angeles, CA, 90005, US

(21) Appl. No.: 10/873,441

(22) Filed: Jun. 23, 2004

Related U.S. Application Data
(63) Continuation-in-part of application No. 10/047,016, filed on Jan. 17, 2002, now abandoned.

(51) Int. Cl. G03B 41/00

(52) U.S. Cl. 396/322

(57) ABSTRACT

A method and instrument for making photos of various background art works with disposable camera. A negative filmstrip with various preset backgrounds in one canister is prepared using a negative image duplicator of this invention in a dark room. The filmstrip is rolled into a canister as conventional photo film and installed in a disposable camera in a dark room. The objective lens of the disposable camera, for a photo of this invention, is covered with an annular mask of black opaque plastic sheet, except for the center, through which only the image of objectives to be taken picture can be seen. Developed photos of this invention are decorated with many phrases and artworks for specific moments surrounding the objective human.

The present application is a continuation in part of the previous U.S. patent application Ser. No. 10/047,016, which is now abandoned.

### BACKGROUND OF THE INVENTION

1. Field of Invention

The present invention relates to a simple method for producing photos having preset backgrounds of various moments with disposable camera loaded with film treated by the method of this invention.

2. Description of the Prior Art

U.S. Pat. No. 5,765,062 and 5,546,146 to Dobbs et al. illustrate a method for preparing a negative filmstrip (16) having one kind of image art work (60) on the position (82) with an apparatus (10) and a positive filmstrip (12). Therefore, every film frame in each filmstrip has the same art work (60). Dobbs et al.'s light blocking system is installed inside of the camera between the objective lens and the film frame. No single sentence describes a light blocking system on the outer surface of the objective lens (58). U.S. Pat No. 6,400,910 to Craig and U.S. Pat. No. 5,565,936 to Kim et al. illustrate a photographic filmstrip in the form of a length of photographic film having a pre-exposed area. The pre-exposed area is continuous and extends along one edge of the strip between ends of the strip. In FIG. 9A to 9D Craig explains how the shift able partition of square plate (102) works. The role of this shift able partition (102) is to adjust the portion of exposure and to protect the preset artworks at the bottom of the filmstrip.

U.S. Pat. No. 4,896,176 to Bratt illustrates a lens cover (23) for Polaroid™ Camera, which is not installed on the lens (13) but apart from the lens (13). It cannot make clear boundary for the picture at the center. U.S. Pat. No. 4,708,449 to Thomas illustrates a mask installed on the frame (15) in front of the objective lens, not on the lens' surface. In this point of view Thomas's mask is more close to Bratt's mask. U.S. Pat. No. 5,546,152 to Fortson teaches to utilize a masking device (10) comprised of three parts to mount a mask (18) and connect the mount to the objective lens (17). U.S. Pat. No. 3,940,775 to Bodnar illustrates a mask assemblies (13), (16) in front of the camera lens. U.S. Pat. No. 4,506,964 to Hayels illustrates a multiple imaging attachment system (26) in front of the objective lens. U.S. Pat. No. 6,289,181 to Lau et al. illustrates a film with artwork mounted to the object side of the lens mounted on a plate (10). .It is obvious to a person having ordinary skill in the art that just adhering a sheet of opaque annular mask film on the objective surface of the lens is much easier and cheaper than those complicate and expensive masking systems of Dobbs et al., Barrett, Thomas, Fortson, Bodnar, Hayles, and Lau et al. None of prior art teaches to directly cover the objective lens of a disposable camera with annular mask of black opaque plastic sheet on the surface of the objective lens to make clear circumferences of the objective picture in the center.

### SUMMARY OF THE INVENTION

It is the object of this invention to provide new simple methods of taking pictures of various backgrounds for different moments with cheap disposable camera.

A negative filmstrip with various preset background art works in one canister is prepared by exposing an unexposed filmstrip to the light passing through a positively developed filmstrip, having a mask circles in the center of each film frame, mounted on the negative image duplicator of this invention in a dark room. The film of this invention is rolled into a canister as conventional photo film and installed in a disposable camera in a dark room before released to the market. The objective lens of the disposable camera for a photo of this invention is masked except for the center through which only the image of human and object to be taken picture can be seen. Developed photos of this invention are decorated with many phrases and figures for specific moments surrounding the objective human.

### BRIEF DESCRIPTION OF FIGURES

FIG. 1 is a positively developed filmstrip decorated with art works and a black masked center.

FIG. 2 is a perspective view of the negative image duplicator.

FIG. 3 is a side view of the negative image duplicator.

FIG. 4 is the layout of the positive and negative filmstrips.

FIG. 5 is the schematic drawing of the negative image duplication.

FIG. 6 is the front view of a disposable camera objective lens masked with annular cover.

FIG. 7 is the photo developed without expose film to an object.

FIG. 8 is the photo developed after taking picture of the object.

### DETAILED DESCRIPTION OF THE PREFERRED EMBODIMENTS

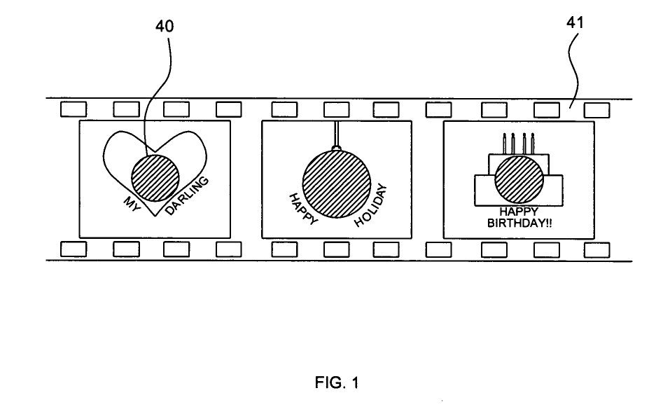

FIG. 1 is a positively developed film stroll, which has a black opaque center of diameter 3.0 to 3.5 mm (40) in each film frame and decorated with various preset artworks prepared by conventional method of taking pictures of different surroundings in each film frame.

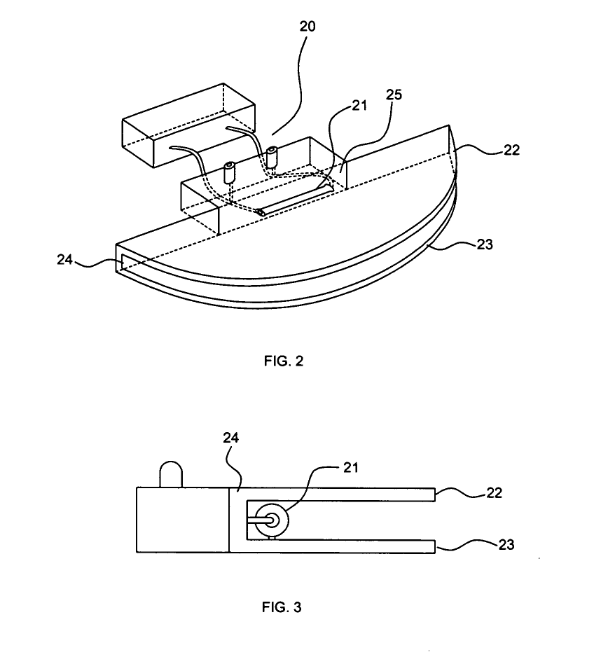

FIG. 2 is the negative image-duplicator (20) of this invention made of 5 mm thick cast iron steel. A light source (21) is installed inside and the opposite site is open as FIG. 3. The image-duplicator (20) is comprised of upper (22) and lower plates (23) of 5 mm thickness cast iron, shaped in hemi-circled with radius of 25 cm, soldered on both sides of a long square plate (24) of 5 mm thickness cast iron. Center of the square plate (24) has an opening for light souce (21).

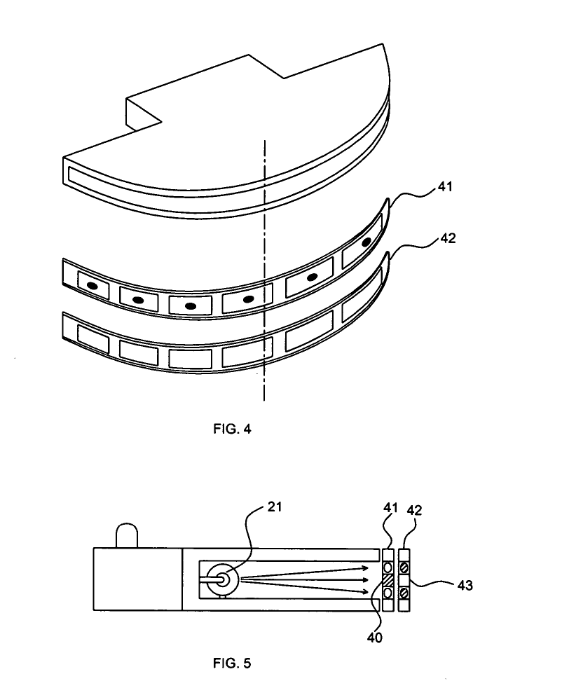

A strip of the positively developed film (41) having positive images of various surrounding art works and black opaque center circle of diameter 3 to 3.5 mm, as shown in FIG. 1, is tightly adhered to the image duplicator (20) with an unexposed filmstrip (42) adhered on the positive filmstrip as shown in FIG. 4.

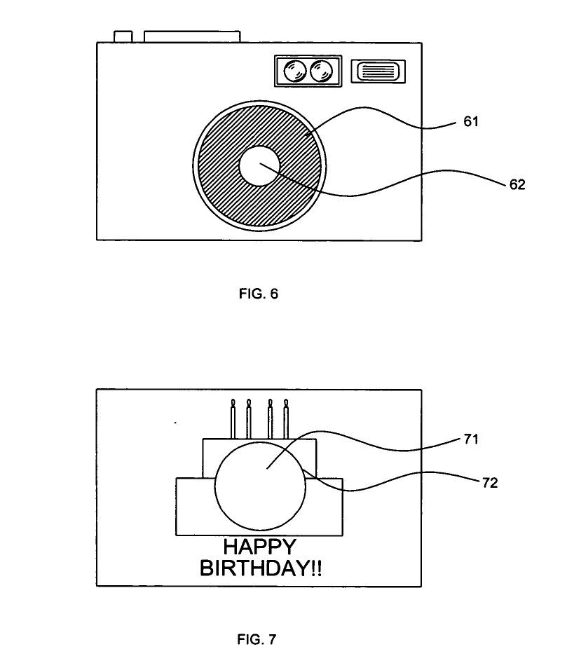

When light passes through a stroll of the positively developed filmstrip (41), as shown in FIG. 5, the black center of each positive film (40) protects the portion (43) of the unexposed film (42), on which the secondary image of the objectives will be imposed when the camera is operated later. The unexposed film (42) became partially exposed film strip which has different surrouding art works in each film strip. This entire step is conducted in a dark room. To protect the preset artwork background and locate the image of the object on the center of a film frame, the objective lens of a disposable camera is directly covered with annular mask (61) on the surface of the lens (62) as shown in FIG. 6 to make clear circumferences (72) of the objective picture (81) in the center.

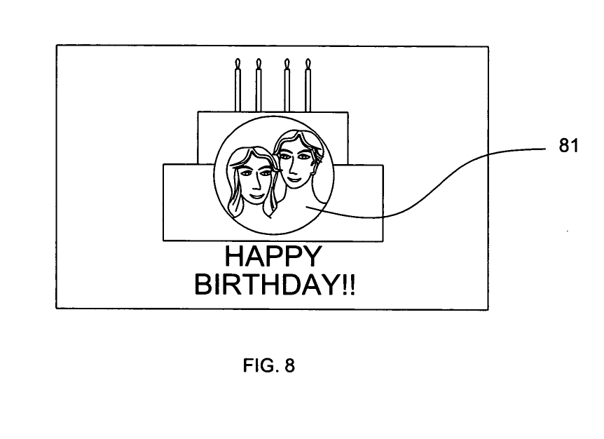

If a negative film (42) of FIG. 5, being exposed to a light from light source (21) to h ave n egative image of background a rtwork, i s d eveloped without t aking picture, then the photo will have white empty center surrounded by preset back-ground art works as shown in FIG. 7.

FIG. 8 is a photograph of this invention taken by a disposable camera covered with an annular mask by the method of this invention and loaded with the negative film having preset background artworks of this invention.

Best mode to take a picture like FIG. 8 is to cover the objective lens of a disposable camera with annular mask of 3 mm inner diameter.

What is claimed is:

1. A simple method for producing photos of various preset backgrounds, which will surround the objectives, to be photographed later, with a disposable camera is comprised of;
1)Prepare a positive filmstrip which has different backgrounds in each film frame by taking picture of different background and developing them positively;
2)Block the center of each film frame with black opaque circle plates of diameter 3 to 3.5 mm;
3)Adhere the positive filmstrip tightly to one unexposed filmstrip in a darkroom;
4)Adhere the two filmstrips to the open gap of the negative image-duplicator in the darkroom;
5)Turn on the light of the negative image-duplicator to expose the two filmstrips to the light; and
6)Install the negative filmstrips, exposed to the surrounding images, into a disposable camera, of which the objective lens is covered with an opaque annular mask of black plastic sheet of inner diameter of 3.0 to 3.5 mm.

2. The negative image-duplicator, in claim 1, is comprised of an upper and a lower plates of 5 mm thickness cast iron, shaped in hemi-circled with radius of 25 cm, soldered on both sides of a long square plate of 5 mm thickness cast iron having an opening for light source at the center.
